(19) United States
(12) Patent Application Publication
(10) Pub. No.: US 2020/0267602 A1
(43) Pub. Date: Aug. 20, 2020

(54) Method and Apparatus for Traffic Management in a Self-Backhauled Network by Using Capacity Grants

(71) Applicant: Telefonaktiebolaget LM Ericsson (publ), Stockholm (SE)

(72) Inventors: Mona Hashemi, Ottowa (CA); Mikael Coldrey, Borås (SE); Henrik Sahlin, Mölnlycke (SE)

(21) Appl. No.: 16/645,029

(22) PCT Filed: Sep. 20, 2017
(86) PCT No.: PCT/EP2017/073836

§ 371 Date: Mar. 6, 2020

(51) Int. Cl. H04W 28/20; H04W 88/14; H04W 28/08; H04W 88/10; H04W 16/10

(52) U.S. Cl. CPC H04W 28/20; H04W 88/14; H04W 16/10; H04W 88/10; H04W 28/0812

(57) ABSTRACT

The present invention describes a radio base station and a method for integrated access and backhaul using capacity grants. The radio base station is configured to allocate a first part of its capacity to access traffic and a second part of its capacity to backhaul traffic. It is further configured to form a self-backhauled network with a plurality of other radio base stations and select a backhaul route through the self-backhauled network for uplink and downlink backhaul traffic.

### TECHNICAL FIELD

Embodiments presented herein relate to a base station and a method in a base station. In particular, embodiments relate to traffic management for integrated access and backhaul traffic.

### BACKGROUND

FIG. 1A depicts a known implementation of a self-backhauled radio base station, RBS, with integrated access and backhaul traffic. The main principle behind self-backhauling is that the radio base station uses its own radio resources for backhaul traffic. Conventionally, a radio base station is equipped with a dedicated backhaul connection, e.g. a microwave radio link, a copper link or a fiber-optic link. However, with the introduction of larger numbers of small cells in future mobile networks, a more cost effective backhaul solution is to let some radio base station allocate part of its own radio resources to backhaul traffic.

In the self-backhauled network of FIG. 1A, the radio base station allocates a first part of its capacity to access traffic, i.e. communication between base station and user equipment, UE, and a second part of its capacity to provide a wireless self-backhaul connection to and from an anchor radio base station.

The anchor base station is connected to the core network, e.g. by a fiber-optic link.

Integrated access and backhaul is specified within 3GPP for LTE relaying. Relaying can in this case be regarded as an access-integrated backhaul technology. In LTE, an in-band relayed eNB, i.e. a self-backhauled RBS, receives its wireless backhaul connection from a donor eNB. The donor eNB thus allocates parts of its radio resources to provide the relayed eNB with backhaul connectivity. The more backhaul capacity the relayed eNB needs, the more radio resources the donor eNB must allocate to backhaul traffic. In such a setup, the radio resources are shared between access and backhaul links which implies that access and backhaul links compete over the same radio resource pool.

The self-backhauled network can also be a multi-hop link. FIG. 1B depicts an example of multi-hop deployment of a self-backhauled network of radio base stations. In a multi-hop deployment, the self-backhauled link from one radio base station is relayed along a certain route of donor radio base stations until it reaches its destination, an anchor RBS. The donor RBS donate a portion of its available wireless resources to forward the backhaul traffic of other radio base stations.

As mentioned above, a problem when deploying access-integrated backhaul networks is that access and backhaul links compete over the same radio resource pool. Hence, an increase in access traffic can lead to shortage of radio resources for backhaul links, especially in a multi-hop deployment where each radio base station of the backhaul chain adds further access traffic on top the incoming backhaul traffic. This can lead to poor backhaul connection, which in turn affects user experience and results in poor usage of radio resources.

The self-backhauled networks described above will easily be overloaded and not able to provide the backhaul capacity required for a consistent user experience. Currently there exist no efficient implementations that remedy this problem. Hence, there is a need for an improved radio base station for integrated access and backhaul traffic that can reduce the problems of network overload and congestion in a self-backhauled network.

### SUMMARY

It is an object of the present invention to remedy, or at least alleviate, some of these drawbacks and to provide an efficient radio base station and method for traffic management in a self-backhauled network. This is provided in a number of aspects of the present invention described below.

According to a first aspect, the invention describes a radio base station for integrated access and backhaul. The radio base station being configured to allocate a first part of its capacity to access traffic and a second part of its capacity to backhaul traffic. The radio base station being further configured to form a self-backhauled network with a plurality of other radio base stations, thus allowing each radio base station to be connected to the core network via the self-backhauled network. The radio base station is comprising a receiver configured to receive incoming capacity grants from adjacent radio base stations in the self-backhauled network, wherein the incoming capacity grants are indicating the capacity granted for backhaul traffic via the respective adjacent radio base station. The radio base station is also comprising a routing unit configured to select a backhaul route based on the incoming capacity grants. The radio base station is also comprising a transmitter configured to transmit the backhaul traffic to an adjacent radio base station in accordance with the selected backhaul route.

According to a second aspect, the invention describes a method in a radio base station, in which the radio base station is configured to allocate a first part of its capacity to access traffic and a second part of its capacity to backhaul traffic. The radio base station is further configured to form a self-backhauled network with a plurality of other radio base stations, thus allowing each radio base station to be connected to the core network via the self-backhauled network. The method is comprising the step of receiving incoming backhaul capacity grants from adjacent radio base stations in the self-backhauled network. The incoming capacity grants indicating the capacity granted for backhaul traffic via the respective adjacent radio base stations. The method is also comprising the step of selecting a backhaul route for the outgoing backhaul traffic of the radio base station based on the incoming backhaul grants. Lastly, the method is comprising the step of transmitting the outgoing backhaul traffic in accordance with the selected backhaul route.

The above radio base station and method can largely avoid network overload and congestion and provide efficient and dynamic traffic management for a self-backhauled network.

### BRIEF DESCRIPTION OF THE DRAWINGS

FIG. 1A shows schematically an example of a conventional single-hop self-backhauled wireless network,

FIG. 1B shows schematically an example of a conventional multi-hop self-backhauled wireless network,

FIG. 2 shows schematically a first example of a multi-hop self-backhauled network according to the present invention,

FIG. 3 shows schematically a second example of a multi-hop self-backhauled network according to the present invention,

FIG. 4 shows schematically a third example of a multi-hop self-backhauled network according to the present invention,

FIG. 5 shows schematically a radio base station configured for integrated access and backhaul traffic according to the present invention,

FIG. 6A shows schematically in a flowchart a method for selecting a backhaul route and transmitting backhaul traffic in a self-backhauled network according to the present invention,

FIG. 6B shows schematically in a flowchart a method for granting backhaul capacity in a self-backhauled network according to the present invention,

FIG. 7A shows schematically a first example of the signalling procedure in a self-backhauled network using capacity grants,

FIG. 7B shows schematically a second example of the signalling procedure in a self-backhauled network using capacity grants,

FIG. 8 shows schematically a third example of the signalling procedure in a self-backhauled network using capacity grants, and

FIG. 9 shows schematically an example of a hardware implementation of the present invention.

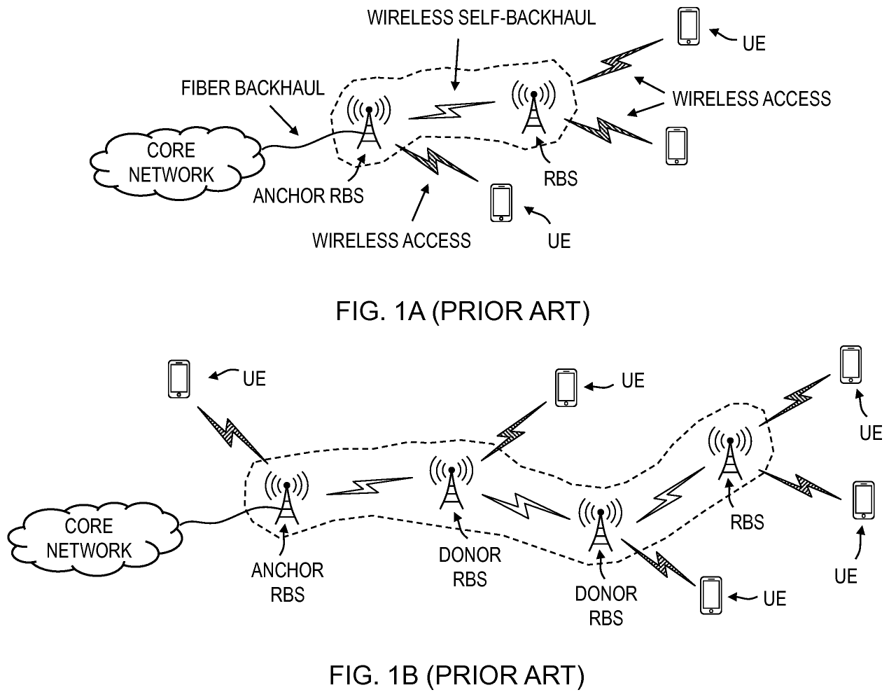

The drawings are not necessarily to scale and the dimensions of certain features may have been exaggerated for the sake of clarity, emphasis is instead being placed upon illustrating the principle of the embodiments herein.

### DETAILED DESCRIPTION

This invention relates to signalling procedure for establishing a backhaul connection between a radio base stations, RBS, and its adjacent radio base stations in a self-backhauled network. The invention also relates to traffic management of said established connection. The invention may be used for both uplink and downlink backhaul traffic, and the invention is applicable to both fixed wireless access and mobile wireless access.

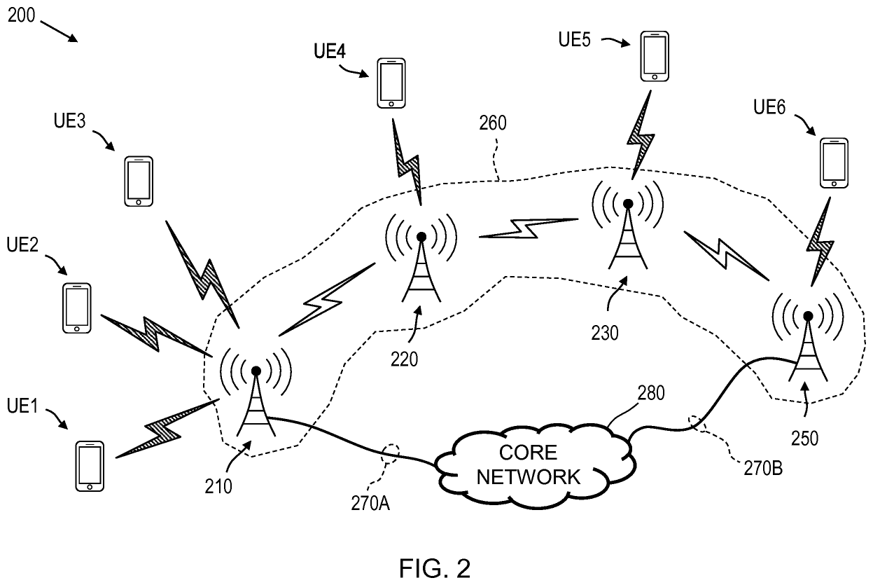

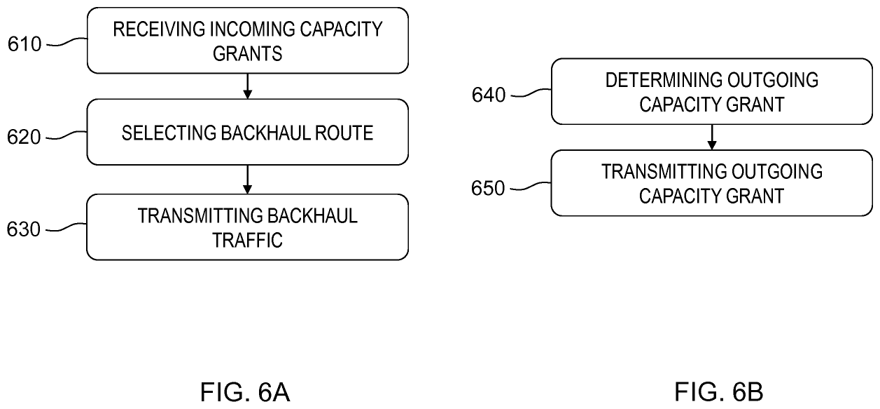

Four embodiments of the present invention are described in detail below with reference to FIGS. 2-8. A first and a second embodiment of the invention relate to a radio base station 230 and a third and fourth embodiment relate to a method in a base station. It should be noted that the scope of the present invention is not limited to the particular embodiments described herein, but only limited by the appended claims.

FIGS. 2-4 show schematically three examples of multi-hop self-backhauled wireless networks. The three examples are comprising the radio base stations RBS 210, RBS 220, RBS 230, RBS 240 and RBS 250, with the user equipments UE1, UE2, UE3, UE4, UE5 and UE6 wirelessly connected to said radio base stations. The invention is described with respect to RBS 230, however, RBS 210, RBS 220, RBS 240 and RBS 250 may be implemented in the same way. A self-backhauled network 260, 360, 460 here refers to a network where the radio base stations use their own available radio resources, i.e. their available capacity, for backhaul traffic rather than a dedicated backhaul link, e.g. microwave, copper or fiber. The radio base stations in the self-backhauled network having their own dedicated backhaul links 270A, 270B are referred to as anchor radio base station 210, 250. All uplink and downlink backhaul traffic will have to pass through one of the anchor radio base stations, RBS 210 and RBS 250.

FIG. 2 depicts a multi-hop deployment 200 of a self-backhauled network 260. The network 260 comprises two anchor radio base stations, RBS 210 and RBS 250, that are connected directly to the core network 280 through dedicated backhaul links 270A, 270B. Hence, the other radio base stations, i.e. RBS 220 and RBS 230, will in this deployment always have two possible backhaul routes through the self-backhauled network 260 to choose from.

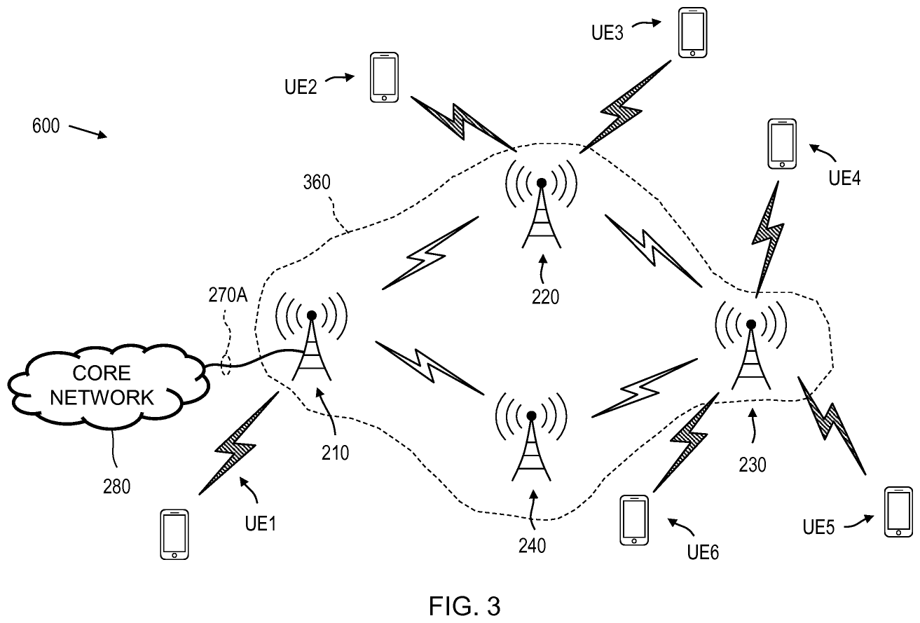

FIG. 3 depicts another multi-hop deployment 300 of a self-backhauled network 360. The self-backhauled network of FIG. 3 differs from that of FIG. 2 in that it only has one anchor RBS, RBS 210. However, the arrangement of the network 360 in a ring will ensure that the other radio base stations, i.e. RBS 220, RBS 230 and RBS 240, have two possible backhaul routes through the self-backhauled network 360 to choose from in this deployment.

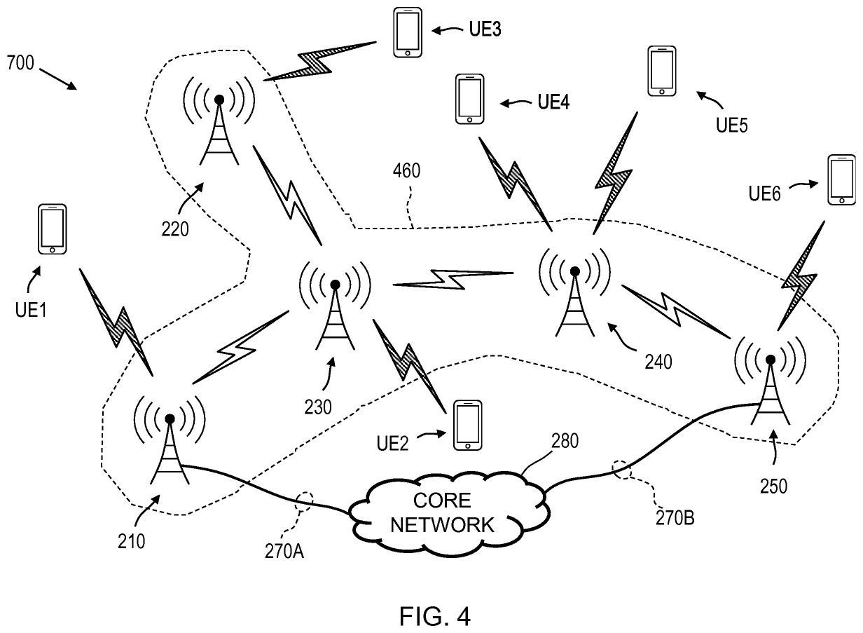

FIG. 4 depicts yet another multi-hop deployment 400 of a self-backhauled network 460. The network 260 comprises two anchor radio base stations,

RBS 210 and RBS 250. RBS 230 and 240 will in this deployment always have two possible backhaul routes. Backhaul traffic to and from RBS 220 will always have to be directed via RBS 230. Hence, RBS 220 should not be used as donor for uplink backhaul traffic.

The first and second embodiments relate to a radio base station 230 for integrated access and backhaul. The radio base station 230 is configured to allocate a first part of its capacity to access traffic and a second part of its capacity to backhaul traffic. The radio base station is further configured to form a self-backhauled network 260, 360, 460 with a plurality of other radio base stations 210, 220, 240, 250. The self-backhauled network may be arranged as a line, a ring, a mesh, a star, a tree or any combination thereof. At least one of the radio base stations of the self-backhauled network needs to be an anchor radio base station 210, 250. The anchor RBS 210, 250 is characterized by having a dedicated backhaul connection, e.g. microwave radio, copper or a fiber-optic link, that is connected to the core network 280. Each radio base station in the self-backhauled network will thus be able to connect to the core network 280 via the self-backhauled network.

In the following, features of the first embodiment are described with reference to FIGS. 2-5, 7A and 7B. The first embodiment relates to the radio base station 230 configured to select a backhaul route in the self-backhauled network.

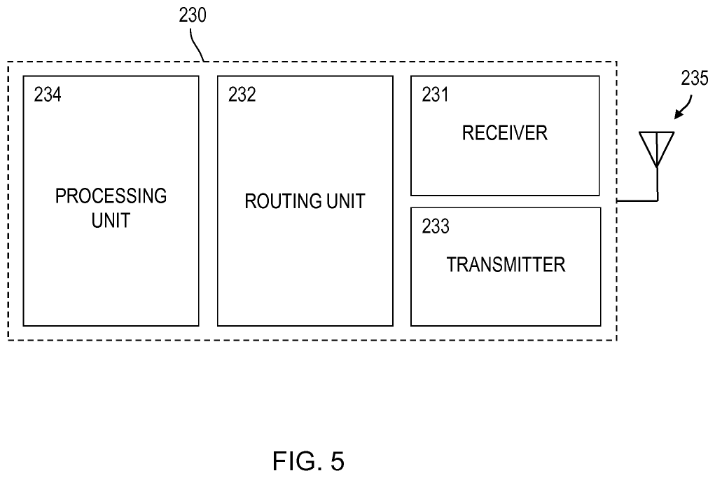

FIG. 5 depicts a radio base station in accordance with both the first and second embodiments. The radio base station 230 according to the first embodiment comprises a transmitter 233, a receiver 231, a routing unit 232. The radio base station further comprises an antenna arrangement 235 connected to the receiver and the transmitter and configured to transmit and receive radio frequency signals. The antenna arrangement may be any type of antenna and with any number of antenna elements. A highly directive antenna, which may in particular be useful for fixed wireless access networks, will enable space-division which can increase the available radio resources for backhaul traffic significantly.

The receiver 231 is configured to receive incoming capacity grants 710B, 720A from adjacent radio base station. Each incoming capacity grant will indicate the granted data rate for backhaul traffic from the radio base station 230 to a target radio base station 210, 220, 240, 250 in the self-backhauled network. The invention works for both uplink and downlink backhaul traffic. For uplink backhaul traffic, the target base station is an anchor radio base station, i.e. RBS 210 or RBS 250. For downlink backhaul traffic, the target base station is a radio base station without a dedicated backhaul link 270A, 270B to the core network 280, i.e. RBS 220 or RBS 240.

The routing unit 222, 232 is configured to select a backhaul route 730A, 730B based on the incoming capacity grants 710B, 720A. Selecting backhaul route may here imply just selecting an adjacent radio base station, or alternatively, it may imply selecting a full route to the target base station. In one example, the routing unit may be configured to select the backhaul route via the adjacent radio base station that provides the highest granted data rate. If several backhaul routes indicate a granted data rate that is greater than or equal to the capacity requirements of RBS 230, the routing unit may be configured to select the backhaul route with the fewest number of hops to the target base station. In another example, the routing unit may be configured to select the backhaul route associated with the first incoming capacity grant having a granted data rate that is greater than or equal to the capacity requirements of RBS 230. In yet another example, the routing unit may be configured to select the backhaul route via the adjacent radio base station that provides the lowest granted data rate that is still greater than the backhaul capacity requirement of RBS 230. In yet another example, the routing unit may be configured to select a first backhaul route 730A, 740A for a first portion of the backhaul traffic, and select a second backhaul route 730B for a second portion of the backhaul traffic.

After the backhaul route has been selected, the transmitter 233 is configured to transmit the backhaul traffic to an adjacent radio base station in accordance with the selected backhaul route.

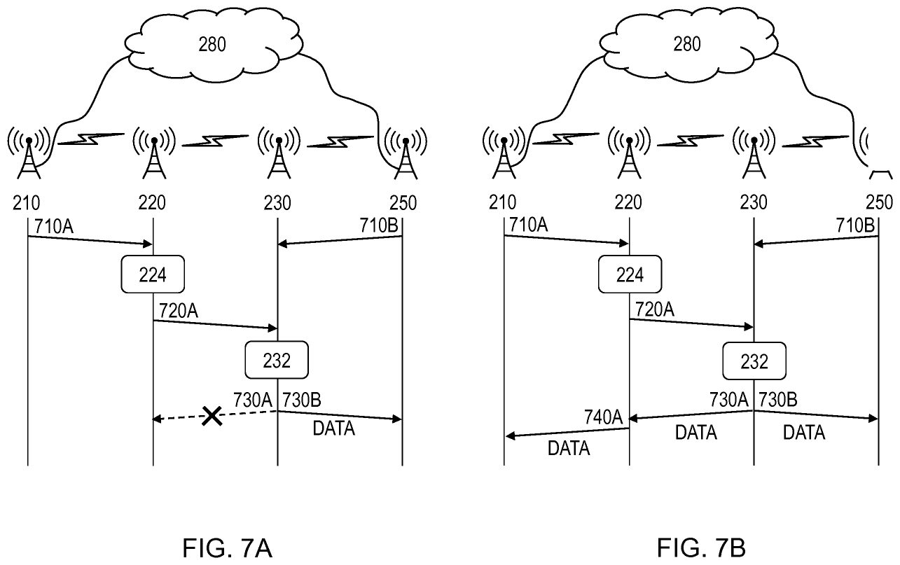

FIGS. 7A and 7B illustrate two examples of the signalling procedure for establishing and transmitting backhaul traffic from the radio base station 230. The two examples are based on the network of FIG. 2 and relate to uplink backhaul traffic.

In the example of FIG. 7A, the anchor radio base stations 210, 250 send outgoing capacity grants 710A, 710B to adjacent radio base stations after assessing their own available radio resources. Capacity grant 710A is incoming capacity grant to RBS 220. RBS 220 takes the incoming capacity grant 710A, assess its own backhaul requirements and available radio resources and sends an outgoing capacity grant 720A to adjacent RBS 230. RBS 230 has two incoming capacity grants 710B, 720A. The capacity grant 720A indicates the granted capacity to anchor base station 210, and the capacity grant 710B indicate the granted capacity to anchor base station 250, In this example, the incoming capacity grant 710B is greater than the capacity requirements of RBS 230, whereas incoming capacity grant 720A is lower than the capacity requirements. In RBS 230, the two incoming capacity grants are input to a routing unit 232. The routing unit selects the only route 730B that offers sufficient capacity.

The example of FIG. 7B follow the same signalling procedure as that of FIG. 7A. However, in this example neither of the incoming capacity grants 710B, 720A has a granted data rate that is sufficiently high for the capacity requirements of RBS 230. Hence, none of the two routes 730A, 730B provides the required backhaul capacity. In this example, the routing unit then selects a first backhaul route 730A for a first portion of the backhaul traffic, and a second backhaul route 730B for a second portion of the backhaul traffic.

In the following, features of the second embodiment are described with reference to FIGS. 2-5 and 8. The features of the first embodiment may also be comprised within the second embodiment. The second embodiment relates to the radio base station 230 configured as a donor RBS.

FIG. 5 depicts a radio base station in accordance with both the first and second embodiments. The radio base station 230 according to the second embodiment comprises a transmitter 233, a receiver 231 and a processing unit 234. The radio base station further comprises an antenna arrangement 235 connected to the receiver and the transmitter.

As mentioned, the incoming capacity grants of an RBS in the self-backhauled network comprises a granted data rate to a target base station. The incoming capacity grants may also comprise other network information, e.g. network topology, number of connected UEs and information about traffic prioritizing. For example, public safety or emergency traffic should be prioritized over other backhaul traffic. Also, time critical traffic, such as voice may have higher prioritizing than other backhaul traffic, e.g. file download.

The processing unit 224, 234 is configured to determine an outgoing capacity grant 820B. The outgoing capacity grant indicate the granted data rate for backhaul traffic from the radio base station 230 to a target radio base station 210, 220, 240, 250 in the self-backhauled network. The second embodiment works for both uplink and downlink backhaul traffic. For uplink backhaul traffic, the target base station is an anchor radio base station, i.e. RBS 210 or RBS 250. For downlink backhaul traffic, the target base station is a radio base station without a dedicated backhaul link 270A, 270B to the core network 280, i.e. RBS 220 or RBS 240.

The granted data rate may be determined based on one or more of the below items:
The access traffic of RBS 230. For example, the processing unit 234 determines the radio resources that RBS 230 needs for wireless access traffic and allocates the remaining radio resources to backhaul traffic.
The backhaul traffic of RBS 230. For example, uplink backhaul traffic that is passing RBS 230 and/or downlink backhaul traffic that is either passing RBS 230 or having RBS 230 as target RBS.
The incoming capacity grants of RBS 230. For example, if RBS 230 receives a granted data rate of zero from anchor RBS 250 of the multi-hop deployment of FIG. 2, it can no longer be donor to any uplink backhaul traffic.
Incoming network information to RBS 230. For example, the processing unit 234 may reduce the radio resources allocated for wireless access traffic to RBS 230 in order to increase radio resources allocated to prioritized backhaul traffic. In another example, the processing unit 234 may reduce the radio resources allocated for wireless access traffic to RBS 230 in order to distribute backhaul capacity fairly among UEs connected to other radio base stations in the self-backhauled network 260, 360, 460.

The granted data rate may further be determined based on the position of the radio base station 230 in the self-backhauled network. For example, a leaf node in the self-backhauled network, e.g. RBS 220 of deployment 400, should never grant capacity to uplink backhaul traffic of any other radio base station.

Lastly, the transmitter 233 is configured to transmit the outgoing capacity grant 820B to an adjacent radio base station.

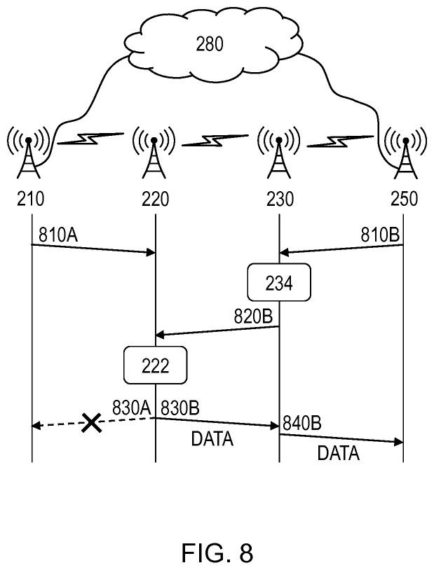

FIG. 8 illustrate an example of the signalling procedure of RBS 230 when configured as a donor RBS. The example is based on the network of FIG. 2 and relates to uplink backhaul traffic.

In the example of FIG. 8, the anchor radio base stations 210, 250 send outgoing capacity grants 810A, 810B to adjacent radio base stations after assessing their own available radio resources. Capacity grant 810B is incoming capacity grant to RBS 230. RBS 230 takes the incoming capacity grant 810A, assess its own backhaul requirements, available radio resources and other network information in a processing unit 234. The processing unit determines a granted capacity rate and RBS 230 sends an outgoing capacity grant 820B to adjacent RBS 220. RBS 220 has two incoming capacity grants 810A, 820B. In this example, the incoming capacity grant 820B is greater than the capacity requirements of RBS 220, whereas the incoming capacity grant 810A is lower. In RBS 220, the two incoming capacity grants are input to a routing unit 222. The routing unit selects the only route 830B that offers sufficient capacity.

The third and fourth embodiments relate to a method in a radio base station 230. The radio base station is configured to allocate a first part of its capacity to access traffic and a second part of its capacity to backhaul traffic. The radio base station is further configured to form a self-backhauled network 260, 360, 460 with a plurality of other radio base stations 210, 220, 240, 250. The self-backhauled network may be arranged as a line, a ring, a mesh, a star, a tree or any combination thereof. At least one of the radio base stations of the self-backhauled network needs to be an anchor radio base station 210, 250. The anchor RBS 210, 250 is characterized by having a dedicated backhaul connection, e.g. microwave radio, copper or a fiber-optic link, that is connected to the core network 280. Thus, allowing each radio base station to be connected to the core network 280 via the other radio base stations in the self-backhauled network.

In the following, features of the third embodiment are described with reference to FIGS. 2-4, 6A and 7. The third embodiment relates to a method in the radio base station 230 for selecting a backhaul route based on incoming capacity grants from an adjacent donor RBS.

The method is comprising the step of receiving 610 incoming capacity grants 710B, 720A from adjacent radio base stations in the self-backhauled network. Each incoming capacity grant indicates the granted data rate for backhaul traffic from the radio base station 230 to a target radio base station in the self-backhauled network. For uplink backhaul traffic, the target base station is an anchor radio base station, i.e. RBS 210 or RBS 250. For downlink backhaul traffic, target base station is a radio base station without a backhaul link 270A, 270B, i.e. RBS 220 or RBS 240.

The method is further comprising the step of selecting 620 a backhaul route for the backhaul traffic of the radio base station 230 based on the incoming backhaul grants 710B, 720A. The step of selecting may involve just selecting an adjacent radio base stations, or alternatively, it may involve selecting the full route to the target base station. In one example, the step of selecting 620 a backhaul route may comprise selecting a backhaul route via the adjacent radio base station that provides the highest granted data rate. If several backhaul routes indicate a granted data rate that is greater than or equal to the capacity requirements of RBS 230, the step of selecting may comprise selecting the backhaul route with the fewest number of hops to the target base station. Thus, reducing latency. Alternatively, if several backhaul routes indicate a granted data rate that is greater than or equal to the capacity requirements of RBS 230, the step of selecting may comprise selecting a backhaul route randomly. In yet another example, the step of selecting 620 a backhaul route may comprise selecting a backhaul route via the adjacent radio base station that provides the lowest granted data rate that is still greater than the backhaul capacity requirement of RBS 230. In yet another example, the routing unit may be configured to select a first backhaul route 730A, 740A for a first portion of the backhaul traffic, and select a second backhaul route 730B for a second portion of the backhaul traffic.

Lastly, the method is further comprising the step of transmitting 630 the backhaul traffic in accordance with the selected backhaul route.

In the following, features of the fourth embodiment are described with reference to FIGS. 2-4, 6B and 7. The features of the third embodiment may also be comprised within the fourth embodiment. The fourth embodiment relates to a method in the radio base station 230 when configured to operate as a donor RBS.

As mentioned earlier, the incoming capacity grants comprises a granted data rate. The incoming capacity grants may also comprise other network information, e.g. network topology, number of connected UEs and information on traffic prioritizing. For example, public safety or emergency traffic should be prioritized over other backhaul traffic. Also, time critical traffic, such as voice may have higher prioritizing than other backhaul traffic, e.g. file download.

The method is further comprising the step of determining 640 an outgoing capacity grant 820B for an adjacent radio base station in the self-backhauled network. The outgoing capacity grant indicates the granted data rate for backhaul traffic to a target radio base station in the self-backhauled network via the radio base station 230. For uplink backhaul traffic, the target base station is an anchor radio base station, i.e. RBS 210 or RBS 250. For downlink backhaul traffic, target base station is a radio base station without a backhaul link 270A, 270B, i.e. RBS 220 or RBS 240.

The step of determining may comprise determining the granted data rate based on one or more of the below items:
The access traffic of RBS 230. For example, the step of determining may comprise determining the outgoing capacity grant as the remaining available radio resources after the radio resources for wireless access traffic to RBS 230 have been allocated.
The backhaul traffic of RBS 230. For example, uplink backhaul traffic that is transmitted via RBS 230 and/or downlink backhaul traffic that is either transmitted via RBS 230 or having RBS 230 as target RBS.
The incoming capacity grants of RBS 230. For example, if RBS 230 receives a granted data rate of zero from anchor RBS 250 in the deployment of FIG. 2, it can no longer be donor to any uplink backhaul traffic.
Incoming network information to RBS 230. For example, the step of determining may further comprise reducing the radio resources allocated for wireless access traffic to RBS 230 in order to increase radio resources allocated to prioritized backhaul traffic. In another example, the step of determining may further comprise reducing the radio resources allocated for wireless access traffic to RBS 230 in order to distribute backhaul capacity fairly among UEs connected to the radio base stations of the self-backhauled network 260, 360, 460.

The step of determining may further comprise determining the granted data rate based on the position of the radio base station 230 in the self-backhauled network 260. For example, a leaf node in the self-backhauled network, e.g. RBS 220 of deployment 400, should never grant capacity to uplink backhaul traffic of any other radio base station.

Lastly, the method is further comprising the step of transmitting 660 the outgoing capacity grant to the adjacent radio base stations in the self-backhauled network.

In the following, some alternative aspects of the four embodiments are described.

According to an aspect of the invention, a fixed minimum radio resource is allocated in a semi persistent manner for the backhaul links between the radio base stations.

According to another aspect of the invention, an RBS receives a plurality of capacity grants from adjacent radio base stations. A third RBS receives a capacity grant from a first RBS. The third RBS also receives a capacity grant from a second RBS. The third RBS removes its own need for backhaul and access and adds the capacity grant from the first RBS and the second RBS. The third RBS then distributes an outgoing capacity grant to a fourth RBS that have a backhaul connection to the third RBS.

According to yet another aspect of the invention, an RBS sends a plurality of capacity grants to adjacent radio base stations. A second RBS receives a capacity grant from at least a first RBS. The second RBS removes its own need for backhaul and access. The second RBS then divides its available resources between a third RBS and a fourth RBS. The first RBS sends a first capacity grant to a third RBS and a second capacity grant to a fourth RBS.

According to yet another aspect of the invention, an RBS may update the outgoing capacity grant based on change in its resource utilization.

According to yet another aspect of the invention, the capacity grant received from other radio base stations may be reduced with the amount of traffic corresponding to devices or UEs for which RBS has a direct access connection.

According to yet another aspect of the invention, each capacity grant may be associated with a prioritization indication.

According to yet another aspect of the invention, an RBS sends a backhaul capacity request to at least one adjacent RBS. This request might be triggered by a high radio resource utilization close to a threshold value. The requested RBS then sends a capacity grant to the requesting RBS based on its own access data and its own capacity grants from other radio base stations. Each RBS, may have a table in which all candidate radio base stations that can potentially provide backhaul connection to it are listed.

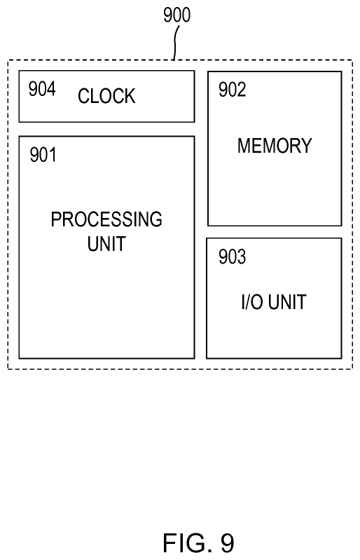

According to yet another aspect of the invention, the radio base station 230 may be implemented as a processing unit 901, a memory 902, input/output unit 903 and a clock 904 as is illustrated in FIG. 9. The processing unit 901, the memory 902, the I/O unit 903 and the clock 904 may be interconnected. The processing unit 901 may comprise a central processing unit, a digital signal processor, a multiprocessor system, programmable logic, a field programmable gate array (FPGA) or an application specific integrated circuit (ASIC) or any other type of logic. The memory 902 may comprise random access memory (RAM), read only memory (ROM) or any other type of volatile or non-volatile memory. The I/O unit 903 may comprise circuitry for controlling and performing signal conversions on I/O data and may further be connected to an antenna.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

1-20. (canceled)

21. A radio base station for integrated access and backhaul, the radio base station being configured to allocate a first part of its capacity to access traffic and a second part of its capacity to backhaul traffic; and the radio base station being further configured to form a self-backhauled network with a plurality of other radio base stations thus allowing each radio base station to be connected to the core network via the self-backhauled network; the radio base station comprising:
a receiver configured to receive incoming capacity grants from adjacent radio base stations in the self-backhauled network, the incoming capacity grants indicating the capacity granted for backhaul traffic via the respective adjacent radio base station;
a routing circuit configured to select a backhaul route based on the incoming capacity grants; and
a transmitter configured to transmit the backhaul traffic to an adjacent radio base station in accordance with the selected backhaul route.

22. The radio base station of claim 21, wherein the incoming capacity grants indicate granted capacity from the radio base station to a target radio base station.

23. The radio base station of claim 21, wherein the routing circuit is configured to select the backhaul route via the adjacent radio base station that provides the highest incoming capacity grant.

24. The radio base station of claim 21, wherein the routing circuit is configured to select the backhaul route via the adjacent radio base station that provides the lowest capacity grant that is greater than the backhaul capacity requirement of radio base station.

25. The radio base station of claim 21, wherein the routing circuit is configured to select a first backhaul route for a first portion of the backhaul, and select a second backhaul route for a second portion of the backhaul traffic.

26. The radio base station of claim 21:
further comprising a processing circuit configured to determine an outgoing capacity grant for an adjacent radio base station in the self-backhauled network, the outgoing capacity grant indicating the capacity granted for incoming backhaul traffic from the adjacent radio base station; and
wherein the transmitter is further configured to send the outgoing capacity grant to the adjacent radio base station.

27. The radio base station of claim 26, wherein the outgoing capacity grant is determined based on access traffic of the radio base station.

28. The radio base station of claim 27, wherein the outgoing capacity grant is further determined based on the incoming capacity grants of the radio base station.

29. The radio base station of claim 21, wherein the backhaul traffic is uplink backhaul traffic and the target base station is an anchor radio base station.

30. The radio base station of claim 21, wherein the backhaul traffic is downlink backhaul traffic and the target base station is a radio base station without a backhaul link.

31. A method in a radio base station, the radio base station configured to allocate a first part of its capacity to access traffic and a second part of its capacity to backhaul traffic; the radio base station further configured to form a self-backhauled network with a plurality of other radio base stations thus allowing each radio base station to be connected to the core network via the self-backhauled network, the method comprising the radio base station:
receiving incoming backhaul capacity grants from adjacent radio base stations in the self-backhauled network, the incoming capacity grants indicating the capacity granted for backhaul traffic via the respective adjacent radio base stations;
selecting a backhaul route for the outgoing backhaul traffic of the radio base station based on the incoming backhaul grants;
transmitting the outgoing backhaul traffic in accordance with the selected backhaul route.

32. The method of claim 31, wherein the incoming capacity grants indicate granted capacity from the radio base station to a target radio base station.

33. The method of claim 31, wherein the selecting the backhaul route comprises selecting a backhaul route via the adjacent radio base station that provides the highest incoming capacity grant.

34. The method of claim 31, wherein the selecting the backhaul route comprises selecting a backhaul route via the adjacent radio base station that provides the lowest capacity grant that is greater than a backhaul capacity requirement of radio base station.

35. The method of claim 31, wherein the selecting the backhaul route comprises selecting a first backhaul route for a first portion of the backhaul traffic, and selecting a second backhaul route for a second portion of the backhaul traffic.

36. The method of claim 31, further comprising:
determining an outgoing capacity grant for an adjacent radio base station in the self-backhauled network, wherein the outgoing capacity grant indicates the capacity granted for backhaul traffic from the adjacent radio base station in the self-backhauled network to the radio base station;
transmitting the outgoing capacity grant to the adjacent radio base stations in the self-backhauled network.

37. The method of claim 36, wherein the determining the outgoing capacity grant for the adjacent radio base station comprises determining the outgoing capacity grant based on access traffic of the radio base station.

38. The method of claim 37, wherein the determining the outgoing capacity grant for the adjacent radio base station comprises determining the outgoing capacity grant based on the incoming capacity grants.

39. The method of claim 31, wherein the backhaul traffic is uplink backhaul traffic and the target base station is an anchor radio base station.

40. The method of claim 31, wherein the backhaul traffic is downlink backhaul traffic and the target base station is a radio base station without a backhaul link.
